(19) United States
(12) Patent Application Publication
(10) Pub. No.: US 2006/0180210 A1
(43) Pub. Date: Aug. 17, 2006

(54) Design of an air flow control valve with double valves

(75) Inventors: Bob X. Li, Grand Blanc, MI (US); Elwood W. Wingeier, Orion, MI (US); Gerald R. Stabel, Swartz Creek, MI (US)

Correspondence Address: PAUL MARSHALL;DELPHI TECHNOLOGIES, INC., Legal Staff, Mail Code: 480-410-202, P.O. Box 5052, Troy, MI, 48007-5052, US

(73) Assignee: Delphi Technologies, Inc., Troy, MI (US)

(21) Appl. No.: 11/056,057

(22) Filed: Feb. 11, 2005

(51) Int. Cl. G01F 5/00

(52) U.S. Cl. 137/599.13

(57) ABSTRACT

An airflow valve and method of providing air may comprise a casing; a single air inlet located in the casing; a first chamber located within the casing and connected to the air inlet; a second chamber located within the casing; a first aperture located in the casing that connects the first chamber to the second chamber; a second aperture located in the casing that also connects the first chamber to the second chamber; a first actuatable member structured to adjustably increase, decrease or stop air flow through the first aperture; a second actuatable member structured to adjustably increase, decrease or stop air flow through the second aperture; and a single air outlet located in the casing and connected to the second chamber.

### BACKGROUND

The advent of fuel cells as alternative propulsion systems or auxiliary power units (APU's) for automotive and other applications, and the advent of advanced engines having capability for lower emissions and better fuel efficiency, have created a need for improved and highly specialized gas flow control valves. This includes diesel fuel reformate valves which may be used with APU fuel cells for example, or to provide Noₓ reductants for emissions control in advanced diesel engines, or for other uses. A reformer or fuel processor, can convert a hydrocarbon fuel (e.g., methane, propane, natural gas, gasoline, diesel, oxygenated hydrocarbons, and the like) to hydrogen or to a less complex hydrocarbon. More particularly, fuel reforming can comprise mixing a hydrocarbon fuel with air, in a mixing zone of the reformer prior to entering a reforming zone of the reformer, and converting the hydrocarbon fuel into, for example, hydrogen (H₂), byproducts, e.g., carbon monoxide (CO), methane (CH₄), inert materials e.g., nitrogen (N₂), carbon dioxide (CO₂), and water (H₂O)). Also, fuel cells for example are known to use hydrogen gas as an energetic fuel for exothermic combination with oxygen at high temperature. Hydrogen may be supplied continuously to a fuel cell as a “reformats” product. Additionally, regarding emissions technology, Hydrogen reformate may need to be directed to a Diesel Particulate Filter (DPF), Nox trap, or other device.

U.S. Pat. No. 4,337,742 shows an idle air control valve that is similar to the idle air control valve found in many modern engines. However, this single valve design has several disadvantages, some of which become acutely apparent when the valve is sized to meet the air flow requirements of a fuel reformer application or an application requiring higher flow at higher pressure than that dictated for an internal combustion engine. If a single valve of this valve design was used for a reformer application or for a high flow application, it would have poor resolution when low air flow is required.

US Patent application to Gagnon, U.S. 2002/0017322 discloses an air control valve for fuel cells. The device has a single air inlet that enters a manifold. The manifold houses two valves, and each valve has its own respective outlet. Since each valve has its own outlet and its own airflow or airmass meter, the resultant air flow total resolution is not controlled as a whole. Rather, separate and distinct sections of the device are controlled to control the total airflow.

Thus, what is needed in the art is a valve that can control airflow to a reformer with a high degree of resolution. In the present device, increased flow and resolution capability are provided by adding a second valve and a second and/or third stage.

### SUMMARY OF THE INVENTION

An embodiment of the present airflow valve may comprise a casing; a single air inlet located in the casing; a first chamber located within the casing and connected to the air inlet; a second chamber located within the casing; a first aperture located in the casing that connects the first chamber to the second chamber; a second aperture located in the casing that also connects the first chamber to the second chamber; a first actuatable member structured to adjustably increase, decrease or stop air flow through the first aperture; a second actuatable member structured to adjustably increase, decrease or stop air flow through the second aperture; and a single air outlet located in the casing and connected to the second chamber.

Another embodiment of the airflow valve may comprise a casing; a single air inlet located in the casing; a first chamber located within the casing and connected to the air inlet; a second chamber located within the casing; a third chamber located within the casing; a first aperture located in the casing that connects the first chamber to the second chamber; a second aperture located in the casing that connects the first chamber to the third chamber; a first actuatable member structured to adjustably increase or decrease air flow through the first aperture; a second actuatable member structured to adjustably increase or decrease air flow through the second aperture; a single air outlet located in the casing and connected to the second chamber and to the third chamber; a third aperture located in the casing that connects the second chamber to the air outlet; and a fourth aperture located in the casing that connects the third chamber to the air outlet.

A method according to an embodiment may comprise: controlling airflow through a valve with high resolution comprising: sending air through a single air inlet located in a casing; sending the air next through a first chamber located within the casing; sending the air to a first aperture located in the casing that connects the first chamber to a second chamber; sending the air additionally to a second aperture located in the casing that also connects the first chamber to the second chamber; adjusting air flow of the air at the first aperture via a first actuatable member structured to adjustably increase, decrease, or prevent air flow through the first aperture; adjusting air flow of the air at the second aperture wherein a second actuatable member is structured to adjustably increase, decrease, or prevent air flow through the second aperture; and sending the air next through a single air outlet located in the casing and connected to the second chamber.

Another method according to an embodiment of the invention may comprise a method for controlling airflow through a valve with high resolution comprising sending air through a single air inlet located in a casing; sending the air next through a first chamber located within the casing; sending the air to a first aperture located in the casing that connects the first chamber to a second chamber; sending the air additionally to a second aperture located in the casing that connects the first chamber to a third chamber; adjusting air flow at the first aperture via a first actuatable member structured to adjustably increase, decrease, or prevent air flow through the first aperture; adjusting air flow at the second aperture wherein a second actuatable member is structured to adjustably increase, decrease, or prevent air flow through the second aperture; and sending the air next through a single air outlet located in the casing and connected to the second and to the third chamber.

### BRIEF DESCIPTION OF THE FIGURES

Embodiments will now be described, by way of example only, with reference to the accompanying drawings which are meant to be exemplary, not limiting, and wherein like elements are numbered alike in several Figures, in which:

FIG. 1 is a perspective view of a first embodiment.

FIG. 2 is a sectional perspective view of the first embodiment.

FIG. 3 is a perspective view of a second embodiment.

FIG. 4 is a sectional perspective view of a second embodiment.

### DETAILED DESCRIPTION OF THE PREFERRED EMBODIMENTS

The present embodiment is an air control valve 1 which may be used with, but is not limited to, use for diesel exhaust after treatment. In fact, the present invention may be used with any air flow valve application. As known in the art and introduced above, a hydrogen reformer may be used to reform diesel gas into hydrogen gas along with carbon monoxide and methane. The reformate is then injected into the diesel engine exhaust stream to react with engine Nox and soot. Hydrogen is used as a reductant to regenerate a NOx trap and a particulate filter from diesel engine emissions. The hydrogen containing reformate is produced by injecting diesel or gasoline fuel and air into a hydrogen reformer mixing chamber, where an igniter starts the gas combustion.

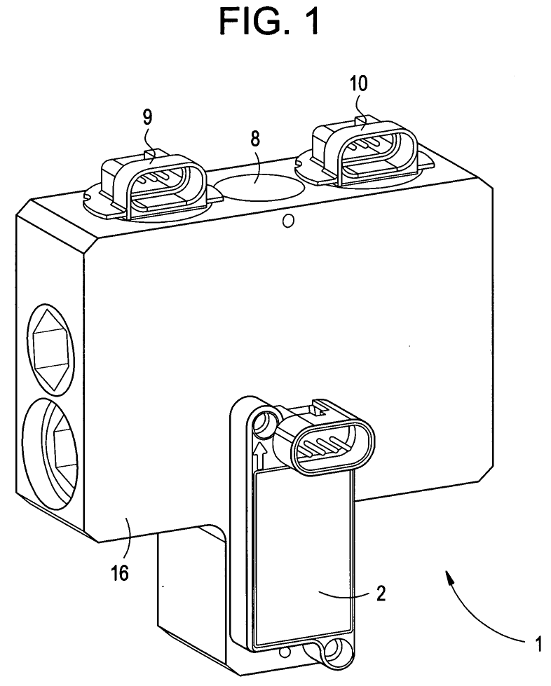

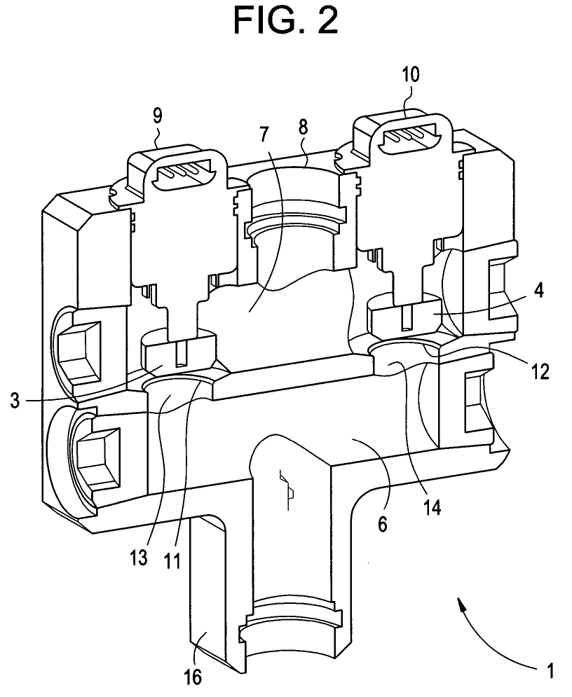

In this example, for diesel reforming, the maximum reformate requirement to regenerate a Nox trap and diesel particular filter is 20 grams per second at 100-kPa pressure. At this flow rate, a large opening air control valve is required to control the amount of air delivery to the reformer (not shown). In this embodiment, as shown in FIGS. 1 and 2, a double pintel design (3,4) is used to control the airflow and an air flow meter 2 is integrated with the air control valve 1.

Specifically, referring to FIG. 1, in the present embodiment, an air control valve 1 is disclosed which may be used to control the air fuel ratio to the reformer (not shown). The outer shell of air flow valve 1 is comprised of a casing 16. In this example, the air fuel ratio sent to the reformer (not shown) is created by a diesel fuel injector (not shown) and the present air control valve 1 working together. The amount of air required for the fuel reforming is metered by the valve and monitored by an air flow meter 2 through a closed loop feedback control to the air pump (not shown) for example to control first actuator 9 and second actuator 10 which controls the first pintel 3 which is an actuatable member and the second pintel 4 in the air control valve 1. Thus, a double valve design is created with an integrated mass air flow meter 2 as shown in FIG. 1.

The air control valve 1 has a one-piece manifold design comprising casing 16. The first and second pintels (3, 4), which are actuatable members, may be driven by two stepper motors or other means serving as first actuator 9 and the second actuator 10. The air flow meter 2 assembly is mounted on the casing 16 of the air control valve 1 to measure the airflow rate. As air enters in the manifold inlet 5, the air passage or path first comprises a first chamber 6 that is provided with two apertures, first aperture 13 and second aperture 14 which form possible passages for the air flow. At each aperture (13,14), a valve seat may be located, i.e., first valve seat 11 and second valve seat 12. The valve seats (11,12) are designed to cooperate and interface with the pintels (3,4) to open and close the apertures (13,14) to form an air channel, and thus, to control the amount of air through each aperture (13,14). After the air passes by the pintels (3,4), the air passages are combined into one channel forming a second chamber 7 which delivers the air to the air usage point via outlet 8. Thus, the pintels may adjustably increase, decrease, or prevent air flow through the apertures (13,14).

In this embodiment, the structure enables the advantageous feature that at low airflow demand, a single first pintel 3 can be operated solely to meter the exact low airflow rate with high resolution while the second pintel 4 remains closed. As air demand increases, the second pintel may start to open and close to meter the higher airflow rate with high resolution. The advantage of this valve design offers improved airflow control or resolution compared to a single pintel design with a large valve opening equivalent to the two valve opening, which cannot offer both high and low air flow rate resolution. Additionally, the present design with two smaller pintels reduces the pintel actuator operating pull force and inertia on each actuator (9,10) as compared to a single larger pintel design with a single larger actuator. Also, the air meter is integrated into the manifold; it does not require an additional pipe connection.

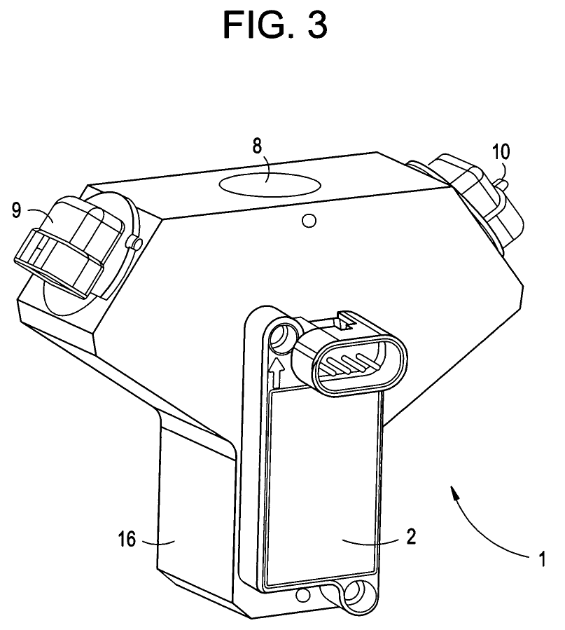

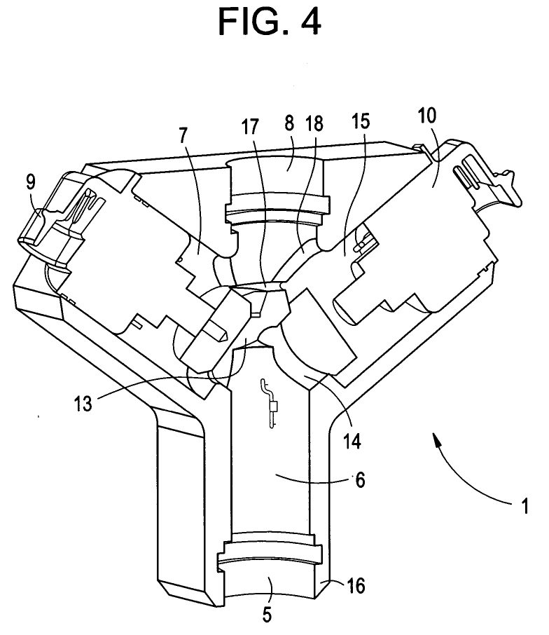

A second embodiment and variation of this valve design is shown in FIGS. 3 and 4. Like parts are numbered as in the first embodiment and are not described again herein. This design mounts the first and second actuators (9,10) at an angle or “V-shape” so that the first and second apertures (13, 14) or airflow passages are located closer together than in the first embodiment. Additionally, third chamber 15 is included. Third aperture 17 and fourth aperture 18 are also included. This design also has the advantages discussed above but also results in less pressure loss through the valve due to its V-shape.

While the preferred embodiment to the invention has been described, it will be understood that those skilled in the art, both now and in the future, may make various improvements and enhancements which fall within the scope of the claims which follow.

1. An airflow valve comprising:
a casing;
a single air inlet located in the casing;
a first chamber located within the casing and connected to the air inlet;
a second chamber located within the casing;
a first aperture located in the casing that connects the first chamber to the second chamber;
a second aperture located in the casing that also connects the first chamber to the second chamber;
a first actuatable member structured to adjustably increase, decrease or stop air flow through the first aperture;
a second actuatable member structured to adjustably increase, decrease or stop air flow through the second aperture; and
a single air outlet located in the casing and connected to the second chamber.

2. The airflow valve of claim 1 further comprising:
at least one valve seat located in at least one of the apertures.

3. The airflow valve of claim 1 wherein at least one pintel comprises at least one of the actuatable members.

4. The airflow valve of claim 1 further comprising:
an air flow meter.

5. The airflow valve of claim 1 further comprising:
an air flow meter integrated into the casing.

6. The airflow valve of claim 1 further comprising:
at least one motor for actuating at least one of the actuatable members.

7. The airflow valve of claim 1 wherein the casing is one piece.

8. An airflow valve comprising:
a casing;
a single air inlet located in the casing;
a first chamber located within the casing and connected to the air inlet;
a second chamber located within the casing;
a third chamber located within the casing;
a first aperture located in the casing that connects the first chamber to the second chamber;
a second aperture located in the casing that connects the first chamber to the third chamber;
a first actuatable member structured to adjustably increase or decrease air flow through the first aperture;
a second actuatable member structured to adjustably increase or decrease air flow through the second aperture;
a single air outlet located in the casing and connected to the second chamber and to the third chamber;
a third aperture located in the casing that connects the second chamber to the air outlet; and
a fourth aperture located in the casing that connects the third chamber to the air outlet.

9. The airflow valve of claim 8 further comprising:
at least one valve seat located in at least one of the apertures.

10. The airflow valve of claim 8 wherein at least one pintel comprises at least one of the actuatable members.

11. The airflow valve of claim 8 further comprising:
an air flow meter.

12. The airflow valve of claim 8 further comprising:
an air flow meter integrated into the casing.

13. The airflow valve of claim 8 further comprising:
at least one motor for actuating at least one of the actuatable members.

14. The airflow valve of claim 8 wherein the casing is one piece.

15. A method for controlling airflow through a valve with high resolution comprising:
sending air through a single air inlet located in a casing;
sending the air next through a first chamber located within the casing;
sending the air to a first aperture located in the casing that connects the first chamber to a second chamber;
sending the air additionally to a second aperture located in the casing that also connects the first chamber to the second chamber;
adjusting air flow of the air at the first aperture via a first actuatable member structured to adjustably increase, decrease, or prevent air flow through the first aperture;
adjusting air flow of the air at the second aperture wherein a second actuatable member is structured to adjustably increase, decrease, or prevent air flow through the second aperture; and
sending the air next through a single air outlet located in the casing and connected to the second chamber.

16. The method of claim 15 further comprising:
sending the air through an air flow meter and adjusting the air flow at the first and second apertures based on air flow data from the air flow meter.

17. A method for controlling airflow through a valve with high resolution comprising:
sending air through a single air inlet located in a casing;
sending the air next through a first chamber located within the casing;
sending the air to a first aperture located in the casing that connects the first chamber to a second chamber;
sending the air additionally to a second aperture located in the casing that connects the first chamber to a third chamber;
adjusting air flow at the first aperture via a first actuatable member structured to adjustably increase, decrease, or prevent air flow through the first aperture;
adjusting air flow at the second aperture wherein a second actuatable member is structured to adjustably increase, decrease, or prevent air flow through the second aperture; and
sending the air next through a single air outlet located in the casing and connected to the second and to the third chamber.

18. The method of claim 17 further comprising:
sending the air through an air flow meter and adjusting the air flow at the first and second apertures based on air flow data from the air flow meter.
